(19) United States
(12) Patent Application Publication
(10) Pub. No.: US 2025/0356162 A1
(43) Pub. Date: Nov. 20, 2025

(54) SYSTEMS AND METHODS FOR NETWORK DEVICE CONFIGURATION NORMALIZATION, INVENTORY MANAGEMENT, AND VISUALIZATION

(71) Applicant: AT&T Intellectual Property I, L.P., Atlanta, GA (US)

(72) Inventors: Sudharani Parvangada, Manalapan, NJ (US); Mercy Chan, Danville, CA (US); Prafulla Verma, Holmdel, NJ (US)

(73) Assignee: AT&T Intellectual Property I, L.P., Atlanta, GA (US)

(21) Appl. No.: 18/667,295

(22) Filed: May 17, 2024

(51) Int. Cl. G06N 3/042; G06N 3/0475

(52) U.S. Cl. CPC G06N 3/042; G06N 3/0475

(57) ABSTRACT

Aspects of the subject disclosure may include, for example, obtaining configuration data indicative of a configuration of a component of a communications network; generating a prompt (based upon the configuration data), wherein the prompt is configured for input to a large language model (LLM); responsive to input of the prompt to the LLM, receiving a knowledge graph that was generated by the LLM; validating the knowledge graph relative to the configuration data (resulting in feedback data); responsive to one or more discrepancies existing between the knowledge graph and the first configuration data, generating an updated prompt (based upon the feedback data), wherein the updated prompt is configured for input to the LLM; responsive to input of the updated prompt to the LLM, receiving an updated knowledge graph that was generated by the LLM; and outputting the updated knowledge graph. Other embodiments are disclosed.

### FIELD OF THE DISCLOSURE

The subject disclosure relates to systems and methods for network device configuration normalization, inventory management, and visualization.

### BACKGROUND

Various conventional manual processes of managing network equipment configurations, inventory, and visualization present several challenges. For example, such a conventional manual process can be time-consuming and error-prone. In particular, manually executing commands such as “show config”, copying the output to a notepad, and interpreting the results is typically a labor-intensive and error-prone process (that often requires significant effort and expertise from network administrators). Another example of a challenge presented by such a manual process is inconsistent knowledge graph creation. In particular, manually researching and creating the knowledge graph (e.g., JSON-LD) can lead to inconsistencies and inaccuracies (due to human error and varying levels of expertise among administrators). Yet another example of a challenge presented by such a manual process is inefficient inventory management. In particular, manually updating inventory assets is a tedious process that can result in outdated or inaccurate information (often affecting the overall network management efficiency). Finally, yet another example of a challenge presented by such a manual process is limited network visualization. In particular, using Mermaid.js to visualize the network manually typically requires additional time and effort (often leading to suboptimal or outdated visual representations of the network topology).

Various conventional approaches to address one or more of the aforementioned challenges have been implemented. For example, one approach to address these challenges has been utilization of network management software. In particular, there exist several conventional network management tools and software solutions that attempt to automate and streamline various aspects of network management (such as device discovery, configuration management, and monitoring). However, such conventional tools often lack the ability to handle diverse network equipment configurations or provide natural language interaction. Another approach to address these challenges has been utilization of scripting and automation. In particular, network administrators have created custom scripts to automate some tasks (such as configuration retrieval and parsing). However, such conventional scripts often require significant expertise to develop and maintain, and may not be universally applicable to different types of network equipment. Yet another approach to address these challenges has been utilization of manual knowledge graph creation. In particular, certain conventional solutions may offer predefined templates or guides to aid in creating knowledge graphs, but they typically still require manual intervention and significant expertise in network equipment and knowledge representation.

Referring now to FIG. 1, this figure shows a certain conventional manual process flow 1000 related to assets inventory and network visualization. As seen in this figure, the process flow 1000 begins with “Generate show command output,” then proceeds to “Copy to text editor,” then proceeds to “View and understand output,” then proceeds to “Research and create knowledge graph,” then proceeds to “Validate knowledge graph manually,” then proceeds to “Manually inventory assets,” then proceeds to “Use mermaid.js visualize network”. This manual process has traditionally been time consuming, repetitive, and error prone.

### BRIEF DESCRIPTION OF THE DRAWINGS

Reference will now be made to the accompanying drawings, which are not necessarily drawn to scale, and wherein:

FIG. 1 is a block diagram illustrating a certain conventional manual process flow.

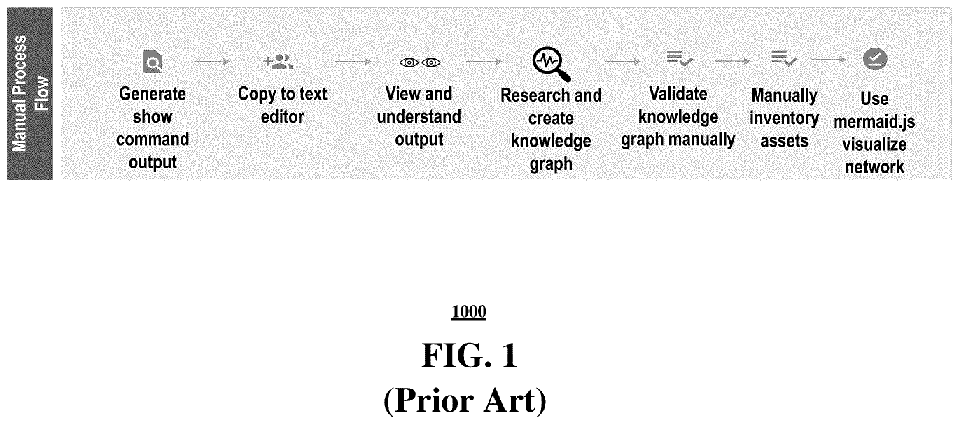

FIG. 2A is a block diagram illustrating an example, non-limiting embodiment of a system in accordance with various aspects described herein.

FIG. 2B is a block diagram illustrating an example, non-limiting embodiment of a system in accordance with various aspects described herein.

FIG. 2C is a block diagram illustrating an example, non-limiting embodiment of a system in accordance with various aspects described herein.

FIG. 2D is a block diagram illustrating an example, non-limiting embodiment of a system in accordance with various aspects described herein.

FIG. 2E is a block diagram illustrating an example, non-limiting embodiment of a system in accordance with various aspects described herein.

FIG. 2F depicts an illustrative embodiment of a method in accordance with various aspects described herein.

FIG. 2G depicts an illustrative embodiment of a method in accordance with various aspects described herein.

FIG. 2H depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for systems and methods for network device configuration normalization, inventory management, and visualization. Other embodiments are described in the subject disclosure.

One or more aspects of the subject disclosure include a device, comprising: a processing system including a processor; and a memory that stores executable instructions that, when executed by the processing system, facilitate performance of operations, the operations comprising: obtaining first configuration data indicative of a first configuration of a first component of a communications network; generating a prompt configured for input to a large language model (LLM), wherein the generating of the prompt is based at least in part upon the first configuration data; facilitating input of the prompt to the LLM; responsive to the input of the prompt to the LLM, receiving a knowledge graph that was generated by the LLM; validating the knowledge graph relative to the first configuration data, wherein the validating comprises determining whether one or more discrepancies exist between the knowledge graph and the first configuration data, and wherein the validating results in feedback data; responsive to the one or more discrepancies existing between the knowledge graph and the first configuration data, generating an updated prompt configured for input to the LLM, wherein the generating of the updated prompt is based at least in part upon the feedback data; facilitating input of the updated prompt to the LLM; responsive to the input of the updated prompt to the LLM, receiving an updated knowledge graph that was generated by the LLM; and outputting the updated knowledge graph.

One or more aspects of the subject disclosure include a non-transitory machine-readable medium comprising executable instructions that, when executed by a processing system including a processor, facilitate performance of operations, the operations comprising: obtaining a knowledge graph indicative of a first configuration of a first component of a communications network, wherein the knowledge graph is obtained from a large language model (LLM) responsive to input to the LLM of a first prompt that had been based upon first configuration data indicative of the first configuration of the first component; generating a second prompt configured for input to the LLM, wherein the generating of the second prompt is based at least in part upon the knowledge graph; facilitating input of the second prompt to the LLM; responsive to the input of the second prompt to the LLM, receiving network visualization data that was generated by the LLM; validating the network visualization data relative to the knowledge graph, wherein the validating comprises determining whether one or more discrepancies exist between the network visualization data and the knowledge graph, and wherein the validating of the network visualization data results in feedback data; responsive to the one or more discrepancies existing between the network visualization data and the knowledge graph, generating an updated prompt configured for input to the LLM, wherein the generating of the updated prompt is based at least in part upon the feedback data; facilitating input of the updated prompt to the LLM; responsive to the input of the updated prompt to the LLM, receiving updated network visualization data that was generated by the LLM; and outputting the updated network visualization data.

One or more aspects of the subject disclosure include a method, comprising: obtaining, by a processing system including a processor, configuration data, wherein the configuration data comprises first configuration data indicative of a first configuration of a first component of a communications network and second configuration data indicative of a second configuration of a second component of the communications network, wherein the first configuration data is in a first format associated with a first component manufacturer, wherein the second configuration data is in a second format associated with a second component manufacturer, wherein the first component manufacturer is a different manufacturer than the second component manufacturer, and wherein the first format is a different format than the second format; generating, by the processing system, a first prompt configured for input to a large language model (LLM), wherein the generating of the first prompt is based at least in part upon the first configuration data; facilitating, by the processing system, input of the first prompt to the LLM; responsive to the input of the first prompt to the LLM, receiving, by the processing system, a first knowledge graph that was generated by the LLM; responsive to the receiving of the first knowledge graph, generating, by the processing system, a second prompt configured for input to the LLM, wherein the generating of the second prompt is based at least in part upon the first knowledge graph; facilitating, by the processing system, input of the second prompt to the LLM; responsive to the input of the second prompt to the LLM, receiving, by the processing system, first network visualization data that was generated by the LLM; and outputting, by the processing system, the first network visualization data.

Various embodiments provide an integrated network management tool that leverages large language models, automation, and natural language processing to streamline and enhance network configuration management, inventory, and visualization. Elements of such embodiments can include:
a) Configuration Normalization—The tool can utilize large language models to parse and normalize diverse device configurations from different network equipment manufacturers (e.g., CISCO, JUNIPER) into a standardized format (e.g., JSON-LD format). This can ensure (or help ensure) consistency and accuracy in managing configurations across various devices in a network.
b) Automated Inventory Management—The tool can integrate inventory database operations using (for example) generated SQL UPSERT statements to simplify the process of adding and updating network equipment information (e.g., into an inventory).
c) LangChain Agents—These can be employed to automatically generate and execute various database (e.g., SQL) statements, significantly reducing manual intervention and increasing efficiency.
d) Network Visualization—The tool can facilitate converting data (e.g., JSON-LD data) into another format (e.g., Mermaid.js), providing a visual representation of the network topology. This automated visualization process can enhance the user's understanding of the network's structure and eliminate (or reduce) the need for manual visualization efforts.
e) Natural Language Processing—The tool can incorporate natural language processing (NLP) through a browser plugin (e.g., CHROME plugin), enabling users to interact with the tool using natural language commands. This user-friendly approach can make the tool more accessible and simplify the network management process.

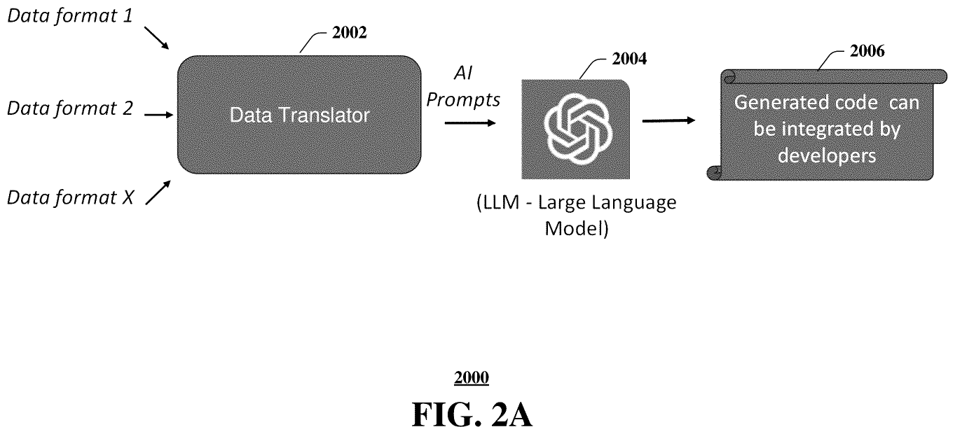

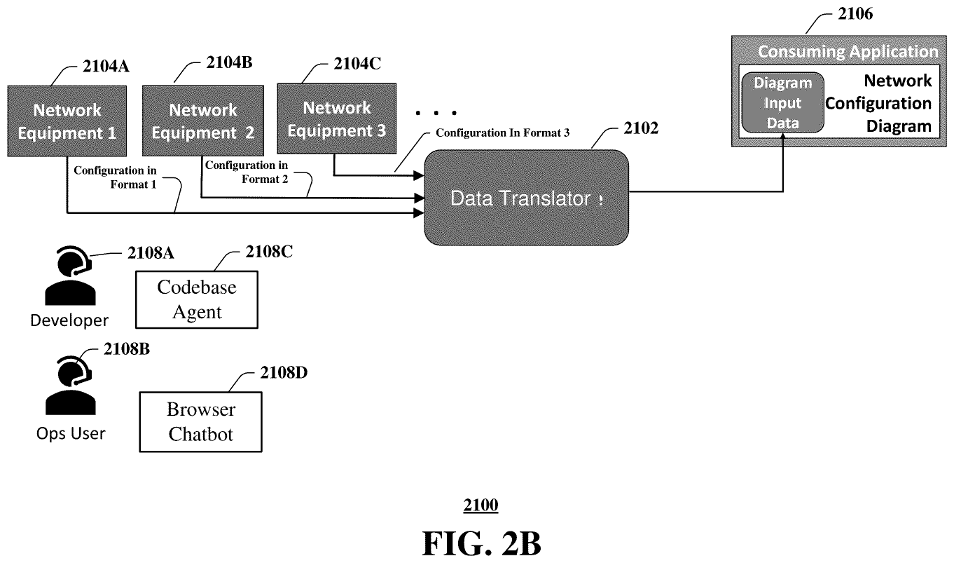

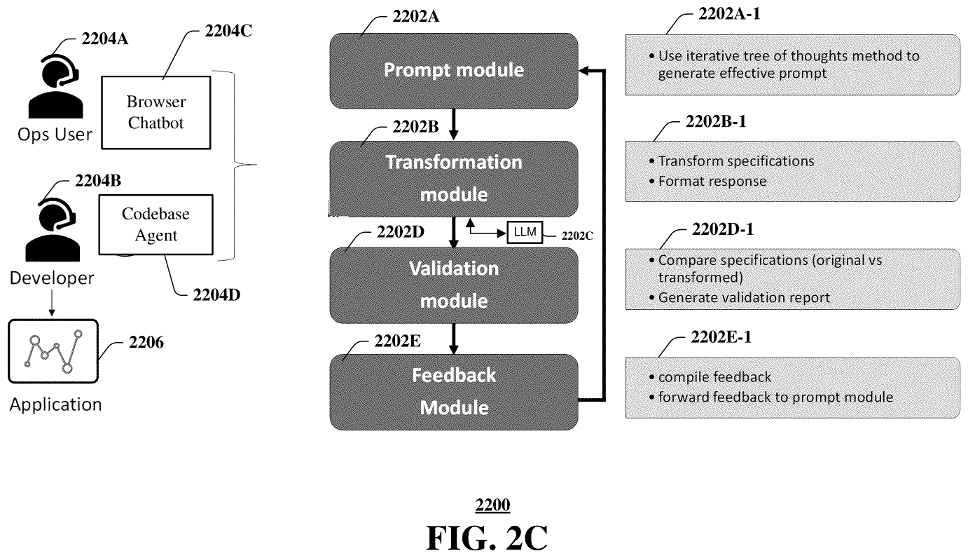

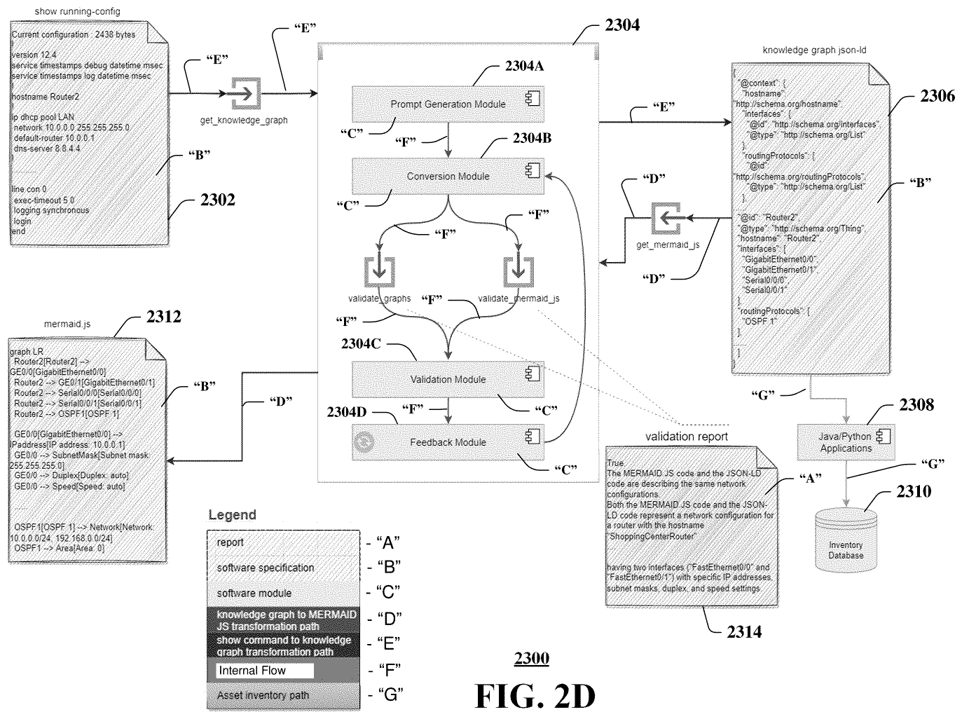

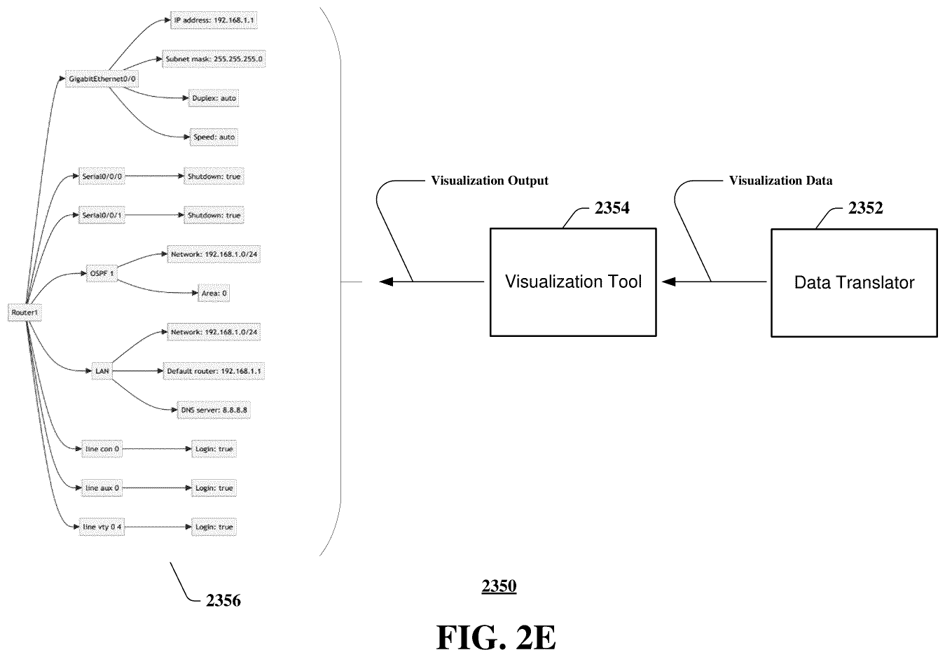

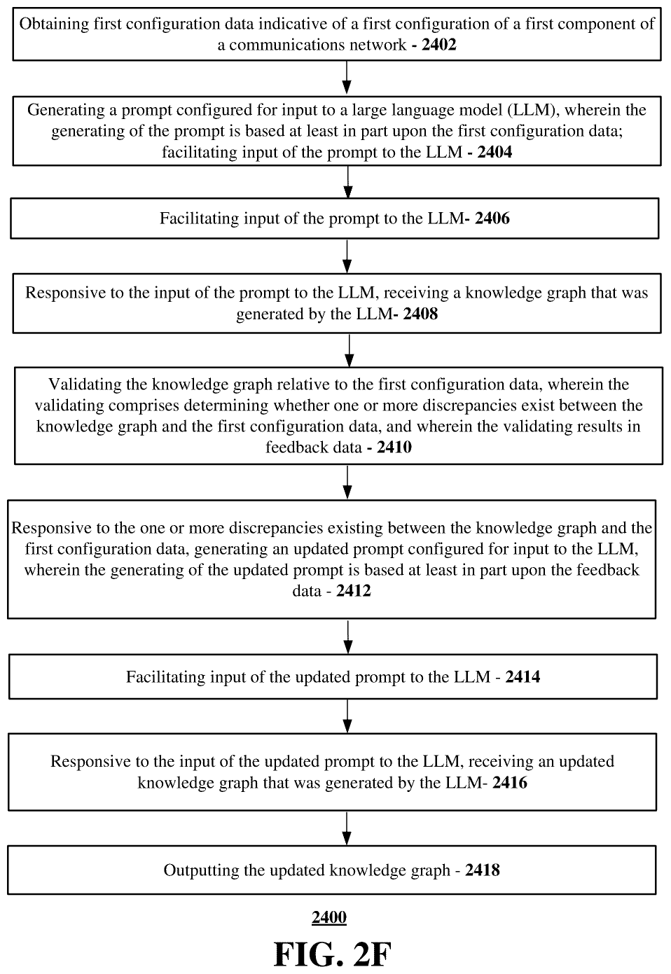

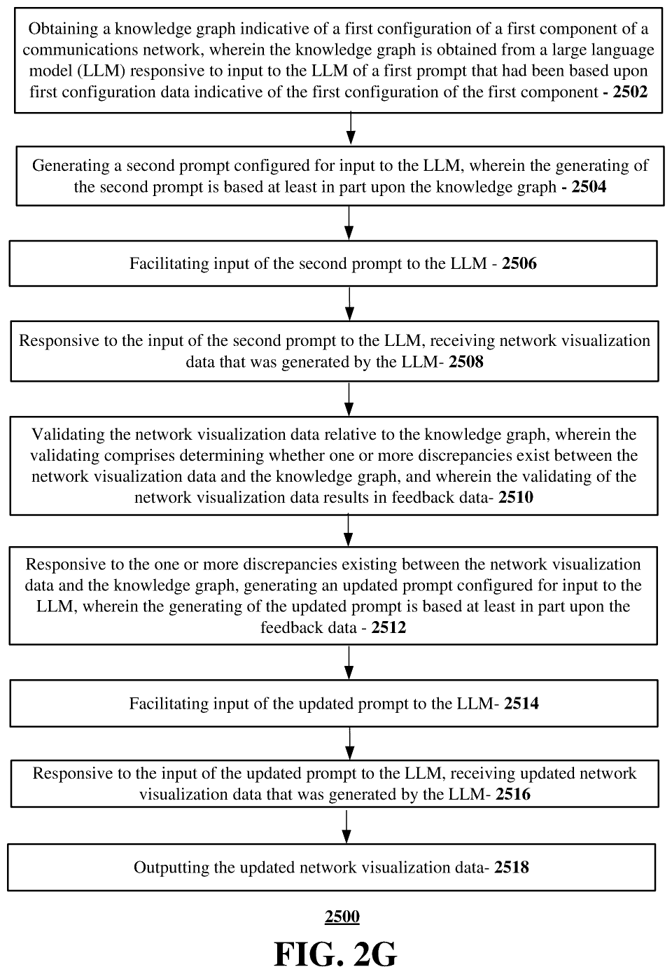

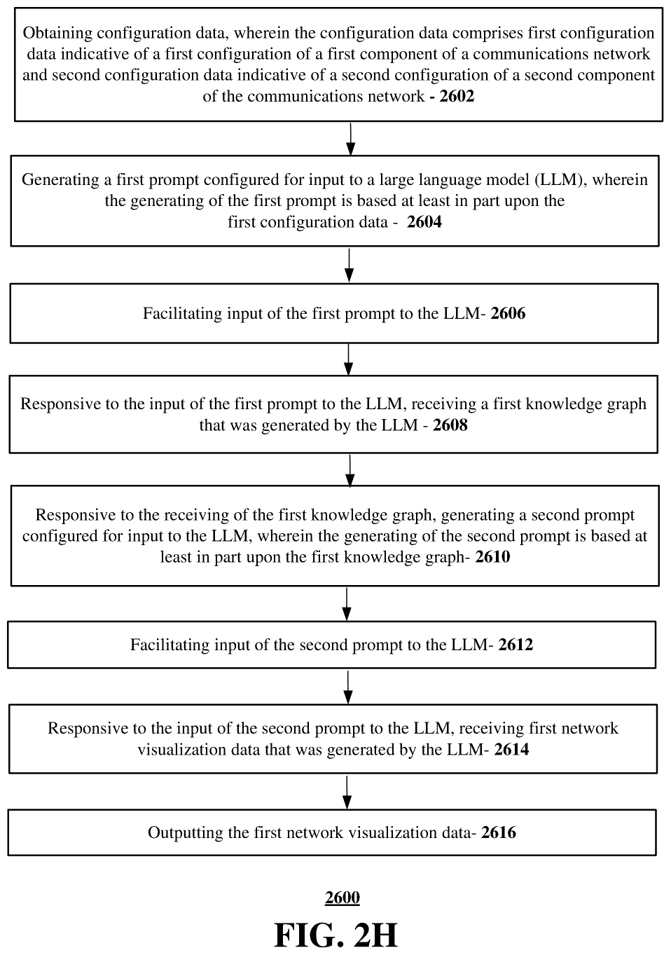

Referring now to FIG. 2A, this is a block diagram illustrating an example, non-limiting embodiment of a system 2000 in accordance with various aspects described herein. As seen in this figure, data translator 2002 (which can be a generic real-time data translator) is configured to receive a plurality of data formats (of course, while three data formats are shown in this figure, any desired number of data formats can be supported). Further, data translator 2002 is configured to output artificial intelligence (AI) prompts that are input to a large language model (LLM) 2004. Further still, the LLM 2004 is configured to output (based at least in part upon the input prompt(s)) generated code 2006 (which can be integrated, for example, by one or more developers). In various embodiments, the system 2000 can be used to: (a) auto-generate code to normalize/transform data; (b) chain together multiple steps to create generative AI app flows; and/or (c) provide a common component supporting multiple scenarios. In various embodiments, the system 2000 can be beneficial by helping to reduce coding effort. In various embodiments, the data translator 2002 can comprise hardware, software, firmware, or any combination thereof.

Referring now to FIG. 2B, this is a block diagram illustrating an example, non-limiting embodiment of a system 2100 in accordance with various aspects described herein. As seen in this figure (which relates to asset inventory and network visualization), data translator 2102 (which can be a generic real-time data translator) is configured to receive configuration data (in various formats) from various pieces of network equipment. More particularly, as shown in this example, data translator 2102 receives: (a) from network equipment 2104A configuration data that is in a first format; (b) from network equipment 2104B configuration data that is in a second format; and (c) from network equipment 2104C configuration data that is in a third format. In one example, each of the first, second and third formats is different from the other. Of course, while three pieces of network equipment (and three data formats) are shown in this figure, any desired number of pieces of network equipment can be supported and any desired number of data formats can be supported. Further, data translator 2102 can output to consuming application 2106 various data (e.g., diagram input data). The consuming application 2106 can then, in turn, generate a network configuration diagram.

Still referring to FIG. 2B, it is noted that in various examples, each of network equipment 2104A, 2104B, 2104C can comprise a router, a switch, or the like. Further, each of network equipment 2104A, 2104B, 2104C can be from a same or a different manufacturer. Each manufacturer can have its own format(s). The data translator 2102 can understand (and/or learn on the fly to understand) each of the configuration formats. In addition, in various embodiments, a user can be a developer 2108A, an operations user 2108B, a codebase software “agent” 2108C, and/or a browser chatbot 2108D. In various examples, a user can interface with the system via an integrated development environment (IDE), a terminal, a software “agent”, and/or a chatbot. In various embodiments, the data translator 2102 can comprise hardware, software, firmware, or any combination thereof.

Referring now to FIG. 2C, this is a block diagram illustrating an example, non-limiting embodiment of a system 2200 in accordance with various aspects described herein. As seen in this figure (which shows a modular architecture that can accommodate different scenarios with minimal changes), the system 2200 includes: prompt module 2202A, transformation module 2202B, LLM (large language model) 2202C, validation module 2202D, and feedback module 2202E. In operation, a process flow can be as follows: (a) the prompt module 2202A uses an iterative tree of thoughts method to generate an effective prompt (see element 2202A-1); (b) the transformation module 2202B then uses data/information that is received from the prompt module 2202A to (using LLM 2202C) transform specifications and format response (see element 2202B-1); the validation module 2202D then uses data/information that is received from the transformation module 2202B to compare specifications (original vs transformed) and generate a validation report (see element 2202D-1); the feedback module 2202E then uses data/information that is received from the validation module 2202D to compile feedback and forward the feedback to the prompt module 2202A (see element 2202E-1). A feedback loop as described above can be completed as many times as desired (e.g., a user-configured number of loops, a user-configured length of time, a user-configured accuracy state, or any combination thereof). In addition, in various embodiments, a user can be an operations user 2204A, a developer 2204B; a browser chatbot 2204C, a codebase software “agent” 2204D. In various examples, a user can interface with an application 2206 directly, via an integrated development environment (IDE), a terminal, a software “agent”, and/or a chatbot. In various embodiments, each of prompt module 2202A, transformation module 2202B, validation module 2202D and/or feedback module 2202E can comprise hardware, software, firmware, or any combination thereof.

Referring now to FIG. 2D, this is a block diagram illustrating an example, non-limiting embodiment of a system 2300 in accordance with various aspects described herein. As seen in this figure (which shows a data format translator flow), the system 2300 includes: data translator 2304, Java/Python applications 2308, and inventory database 2310. Further, as seen, the data translator 2304 includes: prompt generation module 2304A (which can operate, for example, in a manner similar to prompt module 2202A of FIG. 2C), conversion module 2304B (which can operate, for example, in a manner similar to transformation module 2202B of FIG. 2C), validation module 2304C (which can operate, for example, in a manner similar to validation module 2202D of FIG. 2C), and feedback module 2304D (which can operate, for example, in a manner similar to feedback module 2202E of FIG. 2C). In various embodiments, the data translator 2304 can comprise hardware, software, firmware, or any combination thereof.

Still referring to FIG. 2D, in operation, a first process flow can be as follows: (a) a user inputs a data file 2302 into data translator 2304 (in one example, the data file 2302 can be a “show running-config” file and can be input (see arrows “E” into data translator 2304) via a request to “get-knowledge_graph”); (b) the various modules of data translator 2304 can iteratively loop (in a manner similar to that discussed in connection with the modules of system 2200 of FIG. 2C) in order to produce an output file 2306 (in one example, the output file 2306 can be a “knowledge_graph json-ld” file and can be output (see arrow “E” from data translator 2304); the output file 2306 can be sent to Java/Python applications 2308 and/or inventory database 2310 (see arrows “G”).

Still referring to FIG. 2D, in operation, a second process flow can be as follows: (a) output file 2306 is input into data translator 2304 (in one example, the output file 2306 can be a “knowledge_graph json-ld” file and can be input (see arrows “D” into data translator 2304) via a request to “get_mermaid_js”); (b) the various modules of translator 2304 can iteratively loop (in a manner similar to that discussed in connection with the modules of system 2200 of FIG. 2C) in order to produce another output file 2312 (in one example, the another output file can be a “mermaid.js” file and can be output (see arrow “D” from data translator 2304); the another output file 2312 can be sent to an application to form a visualization (as described, for example, in more detail below).

Still referring to FIG. 2D, a validation report 2314 can be output (such a validation report can indicate validation results regarding the output file 2306 and the another output file 2312). Further, as seen in the Legend, a report is associated with a call-out letter “A”, a software specification is associated with a call-out letter “B”, a software module is associated with a call-out letter “C”, a knowledge graph to mermaid.js transformation path is associated with a call-out letter “D”, a show command to knowledge graph transformation path is associated with a call-out letter “E”, an internal flow is associated with a call-out letter “F”, and an asset inventory path is associated with a call-out letter “G”.

Referring now to FIG. 2E, this is a block diagram illustrating an example, non-limiting embodiment of a system 2350 in accordance with various aspects described herein. As seen in this figure, the system 2350 includes: data translator 2352 and visualization tool 2354. The data translator 2350 can operate as described herein to provide as an output certain visualization data (see, e.g., mermaid.js file 2312 of FIG. 2D). Further, the visualization data can be input to visualization tool 2354 (which can comprise, for example, hardware, software, firmware, or any combination thereof) in order to generate visualization 2356 (which can be in the form, for example, of a hierarchical graph).

Referring now to FIG. 2F, various steps of a method 2400 according to an embodiment are shown. As seen in this FIG. 2F, step 2402 comprises obtaining first configuration data indicative of a first configuration of a first component of a communications network. Next, step 2404 comprises generating a prompt configured for input to a large language model (LLM), wherein the generating of the prompt is based at least in part upon the first configuration data. Next, step 2406 comprises facilitating input of the prompt to the LLM. Next, step 2408 comprises responsive to the input of the prompt to the LLM, receiving a knowledge graph that was generated by the LLM. Next, step 2410 comprises validating the knowledge graph relative to the first configuration data, wherein the validating comprises determining whether one or more discrepancies exist between the knowledge graph and the first configuration data, and wherein the validating results in feedback data. Next, step 2412 comprises responsive to the one or more discrepancies existing between the knowledge graph and the first configuration data, generating an updated prompt configured for input to the LLM, wherein the generating of the updated prompt is based at least in part upon the feedback data. Next, step 2414 comprises facilitating input of the updated prompt to the LLM. Next, step 2416 comprises responsive to the input of the updated prompt to the LLM, receiving an updated knowledge graph that was generated by the LLM. Next, step 2418 comprises outputting the updated knowledge graph.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2G, various steps of a method 2500 according to an embodiment are shown. As seen in this FIG. 2G, step 2502 comprises obtaining a knowledge graph indicative of a first configuration of a first component of a communications network, wherein the knowledge graph is obtained from a large language model (LLM) responsive to input to the LLM of a first prompt that had been based upon first configuration data indicative of the first configuration of the first component. Next, step 2504 comprises generating a second prompt configured for input to the LLM, wherein the generating of the second prompt is based at least in part upon the knowledge graph. Next, step 2506 comprises facilitating input of the second prompt to the LLM. Next, step 2508 comprises responsive to the input of the second prompt to the LLM, receiving network visualization data that was generated by the LLM. Next, step 2510 comprises validating the network visualization data relative to the knowledge graph, wherein the validating comprises determining whether one or more discrepancies exist between the network visualization data and the knowledge graph, and wherein the validating of the network visualization data results in feedback data. Next, step 2512 comprises responsive to the one or more discrepancies existing between the network visualization data and the knowledge graph, generating an updated prompt configured for input to the LLM, wherein the generating of the updated prompt is based at least in part upon the feedback data. Next, step 2514 comprises facilitating input of the updated prompt to the LLM. Next, step 2516 comprises responsive to the input of the updated prompt to the LLM, receiving updated network visualization data that was generated by the LLM. Next, step 2518 comprises outputting the updated network visualization data.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2H, various steps of a method 2600 according to an embodiment are shown. As seen in this FIG. 2H step 2602 comprises obtaining, by a processing system including a processor, configuration data, wherein the configuration data comprises first configuration data indicative of a first configuration of a first component of a communications network and second configuration data indicative of a second configuration of a second component of the communications network, wherein the first configuration data is in a first format associated with a first component manufacturer, wherein the second configuration data is in a second format associated with a second component manufacturer, wherein the first component manufacturer is a different manufacturer than the second component manufacturer, and wherein the first format is a different format than the second format. Next, step 2604 comprises generating, by the processing system, a first prompt configured for input to a large language model (LLM), wherein the generating of the first prompt is based at least in part upon the first configuration data. Next, step 2606 comprises facilitating, by the processing system, input of the first prompt to the LLM. Next, step 2608 comprises responsive to the input of the first prompt to the LLM, receiving, by the processing system, a first knowledge graph that was generated by the LLM. Next, step 2610 comprises responsive to the receiving of the first knowledge graph, generating, by the processing system, a second prompt configured for input to the LLM, wherein the generating of the second prompt is based at least in part upon the first knowledge graph. Next, step 2612 comprises facilitating, by the processing system, input of the second prompt to the LLM. Next, step 2614 comprises responsive to the input of the second prompt to the LLM, receiving, by the processing system, first network visualization data that was generated by the LLM. Next, step 2616 comprises outputting, by the processing system, the first network visualization data.

While for purposes of simplicity of explanation, the respective processes are shown and described as a series of blocks in FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments can implement a network management tool that provides technical benefits. Such technical benefits can include one or more of:
a) Streamlined processes—The tool's ability to normalize diverse device configurations, automate inventory management, and generate network visualizations can significantly streamline network management tasks, resulting in more efficient processes.
b) Enhanced accuracy—By leveraging large language models and automation, the tool can minimize human error and inconsistencies in configuration normalization, inventory updates, and network visualization, leading to more accurate and reliable data.
c) Improved interoperability—Use of a standardized JSON-LD format allows for better interoperability among different network devices, simplifying network management and ensuring seamless integration across diverse equipment.
d) User-friendly interaction—The incorporation of natural language processing makes the tool more accessible to users with varying levels of expertise, encouraging wider adoption and usage within organizations.

As described herein, various embodiments can implement a network management tool that provides commercial benefits. Such commercial benefits can include one or more of:
a) Cost savings—The tool's automation capabilities can reduce the time and effort spent on manual network management tasks, leading to potential cost savings in labor and resources.
b) Competitive advantage-Organizations that adopt the integrated network management tool can gain a competitive edge by having more efficient and accurate network management processes, leading to better decision-making, improved network performance, and enhanced customer satisfaction.
c) Scalability—The tool's ability to handle diverse network equipment and configurations makes it adaptable to various network environments and easily scalable as an organization's network grows and/or changes.

As described herein, various embodiments can provide the ability to handle diverse network equipment configurations and/or provide natural language interaction.

As described herein, various embodiments can be universally (or nearly universally) applicable to different types of network equipment.

As described herein. various embodiments can provide easier management and interoperability across different devices in a network.

As described herein, various embodiments can address the challenges of managing increasingly complex networks with diverse equipment.

As described herein, various embodiments can streamline inventory management processes with automation and/or LangChain Agents.

As described herein, various embodiments can improve user experience through natural language interaction and visualization capabilities.

As described herein, various embodiments can provide a tool for Network Device Configuration Normalization, Inventory Management, and Visualization (one or more of which can be LLM-based).

As described herein, various embodiments can provide a graphical user interface (GUI) to allow a person (e.g., operations personnel) to use natural language for giving input. In one example, the GUI can be implemented via a browser extension (e.g. a CHROME extension). In one example, a backend can utilize LLM and/or LangChain to perform normalization, automated inventory management, and/or network visualization.

As described herein, various embodiments can provide streamlined network management processes, improved accuracy, enhanced interoperability, and/or cost savings, all of which contribute to a more efficient and productive network environment.

As described herein, various embodiments can overcome challenges traditionally posed by conventional manual processes in network management, inventory, and visualization. These challenges can be overcome by, for example, integrating (according to various embodiments) configuration normalization, automated inventory management, network visualization, and natural language processing in a single tool.

As described herein, various embodiments can provide a generic real-time data translator that can utilize AI prompts and a large language model to convert among different formats in order to generate code which can be integrated by developers.

As described herein, various embodiments can provide a translator mechanism that can be configured as a smart agent (which operates using, e.g., a large language model such as GPT 4). The translator mechanism can, for example, receive a variety of outputs from a variety of vendors and generate output that is normalized (e.g., into a standard template or format).

As described herein, various embodiments can provide a translator mechanism that creates a network diagram on the fly (e.g. without human interaction).

As described herein, various embodiments can provide a validation report (e.g., for most recent output) that shows the difference between what was expected versus what the tool generated.

As described herein, various embodiments can provide feedback refinement.

As described herein, various embodiments can facilitate configuration of network equipment (e.g., a switch, the software for switch).

As described herein, various embodiments can provide data to facilitate generation of a network configuration diagram.

As described herein, various embodiments can provide a mechanism that finds one or more discrepancies (e.g., one or more missing elements) via iteratively looping.

As described herein, various embodiments can provide a mechanism that is self-correcting or self-healing (e.g., by operating in a way that compares an input (which is a truth) with its own output, and then iterates until they perfectly match (or match within a threshold value).

As described herein, various embodiments can provide a mechanism in which AI prompts are regenerated and refined based on a feedback module (or refinement module).

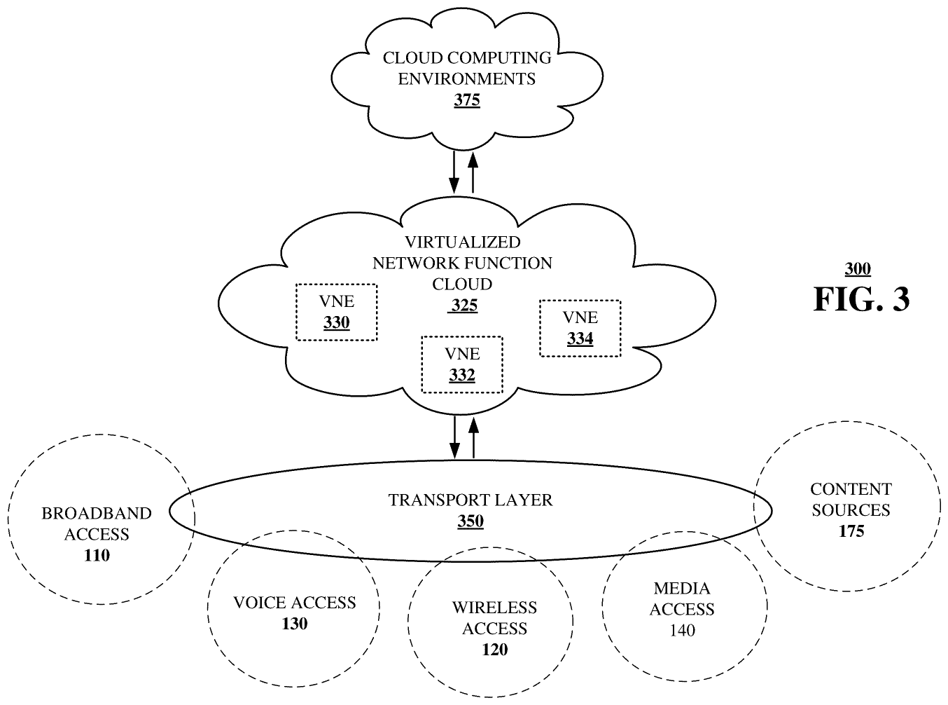

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 2000, some or all of the subsystems and functions of system 2100, some or all of the subsystems and functions of system 2200, some or all of the subsystems and functions of system 2300, some or all of the subsystems and functions of system 2350, and/or the functions of methods 2400, 2500, 2600. For example, virtualized communication network 300 can facilitate in whole or in part systems and methods for network device configuration normalization, inventory management, and visualization.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of various network elements. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element, such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

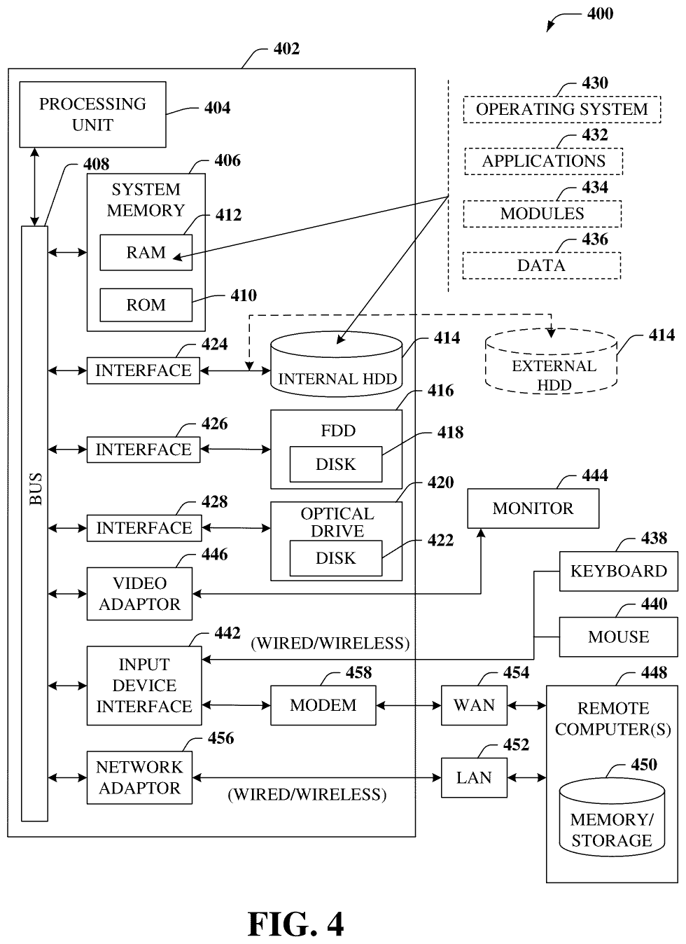

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of various network elements, access terminal base station or access point, switching device, media terminal, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods for network device configuration normalization, inventory management, and visualization.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Various embodiments described herein can employ artificial intelligence (AI) to facilitate automating one or more features described herein. The embodiments (e.g., in connection with automatically performing network device configuration normalization, inventory management, and visualization) can employ various AI-based schemes for carrying out various embodiments thereof. Moreover, the classifier can be employed to determine a ranking or priority of each piece of network equipment. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the pieces of network equipment is to receive priority.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining first configuration data indicative of a first configuration of a first component of a communications network;
generating a prompt configured for input to a large language model (LLM), wherein the generating of the prompt is based at least in part upon the first configuration data;
facilitating input of the prompt to the LLM;
responsive to the input of the prompt to the LLM, receiving a knowledge graph that was generated by the LLM;
validating the knowledge graph relative to the first configuration data, wherein the validating comprises determining whether one or more discrepancies exist between the knowledge graph and the first configuration data, and wherein the validating results in feedback data;
responsive to the one or more discrepancies existing between the knowledge graph and the first configuration data, generating an updated prompt configured for input to the LLM, wherein the generating of the updated prompt is based at least in part upon the feedback data;
facilitating input of the updated prompt to the LLM;
responsive to the input of the updated prompt to the LLM, receiving an updated knowledge graph that was generated by the LLM; and
outputting the updated knowledge graph.

2. The device of claim 1, wherein the operations further comprise storing the updated knowledge graph in a database.

3. The device of claim 1, wherein the LLM is part of an artificial intelligence (AI) system.

4. The device of claim 3, wherein the prompt is an AI prompt.

5. The device of claim 4, wherein the input of the AI prompt comprises directly inputting the AI prompt to the AI system, inputting the AI prompt to the AI system via one or more interfaces, or any combination thereof.

6. The device of claim 1, wherein:
the prompt includes some or all of the first configuration data;
the updated prompt includes some or all of the first configuration data; or
any combination thereof.

7. The device of claim 1, wherein the updated knowledge graph is in a JavaScript Object Notation (JSON) LD file.

8. The device of claim 1, wherein the generating of the updated prompt is based at least in part upon the feedback data and the first configuration data.

9. The device of claim 1, wherein the communications network comprises a plurality of routers and a plurality of switches.

10. The device of claim 9, wherein the first component of the communications network comprises a first router of the plurality of routers, a first switch of the plurality of switches, or any combination thereof.

11. The device of claim 1, wherein:
the first configuration data is in a first format; and
the operations further comprise:
obtaining second configuration data indicative of a second configuration of a second component of the communications network, the second component being a different component than the first component, the second configuration data being in a second format that is different from the first format;
generating another prompt configured for input to the LLM, wherein the generating of the another prompt is based at least in part upon the second configuration data;
facilitating input of the another prompt to the LLM;
responsive to the input of the another prompt to the LLM, receiving another knowledge graph that was generated by the LLM;
validating the another knowledge graph relative to the second configuration data, wherein the validating of the another knowledge graph comprises determining whether one or more other discrepancies exist between the another knowledge graph and the second configuration data, and wherein the validating the another knowledge graph results in other feedback data;
responsive to the one or more other discrepancies existing between the another knowledge graph and the second configuration data, generating another updated prompt configured for input to the LLM, wherein the generating of the another updated prompt is based at least in part upon the other feedback data;
facilitating input of the another updated prompt to the LLM;
responsive to the input of the another updated prompt to the LLM, receiving another updated knowledge graph that was generated by the LLM; and
outputting the another updated knowledge graph.

12. The device of claim 11, wherein the operations further comprise storing the another updated knowledge graph in a database.

13. The device of claim 1, wherein the operations further comprise:
responsive to the receiving of the updated knowledge graph, generating another prompt configured for input to the LLM, wherein the generating of the another prompt is based at least in part upon the updated knowledge graph;
facilitating input of the another prompt to the LLM;
responsive to the input of the another prompt to the LLM, receiving network visualization data that was generated by the LLM;
validating the network visualization data relative to the first configuration data, wherein the validating comprises determining whether one or more other discrepancies exist between the network visualization data and the first configuration data, and wherein the validating of the network visualization data results in other feedback data;
responsive to the one or more other discrepancies existing between the network visualization data and the first configuration data, generating another updated prompt configured for input to the LLM, wherein the generating of the another updated prompt is based at least in part upon the other feedback data;
facilitating input of the another updated prompt to the LLM;
responsive to the input of the another updated prompt to the LLM, receiving updated network visualization data that was generated by the LLM; and
outputting the updated network visualization data.

14. The device of claim 13, wherein the updated network visualization data is configured to facilitate generation of a visualization of a network topography.

15. A non-transitory machine-readable medium comprising executable instructions that, when executed by a processing system including a processor, facilitate performance of operations, the operations comprising:
obtaining a knowledge graph indicative of a first configuration of a first component of a communications network, wherein the knowledge graph is obtained from a large language model (LLM) responsive to input to the LLM of a first prompt that had been based upon first configuration data indicative of the first configuration of the first component;
generating a second prompt configured for input to the LLM, wherein the generating of the second prompt is based at least in part upon the knowledge graph;
facilitating input of the second prompt to the LLM;
responsive to the input of the second prompt to the LLM, receiving network visualization data that was generated by the LLM;
validating the network visualization data relative to the knowledge graph, wherein the validating comprises determining whether one or more discrepancies exist between the network visualization data and the knowledge graph, and wherein the validating of the network visualization data results in feedback data;
responsive to the one or more discrepancies existing between the network visualization data and the knowledge graph, generating an updated prompt configured for input to the LLM, wherein the generating of the updated prompt is based at least in part upon the feedback data;
facilitating input of the updated prompt to the LLM;
responsive to the input of the updated prompt to the LLM, receiving updated network visualization data that was generated by the LLM; and
outputting the updated network visualization data.

16. The non-transitory machine-readable medium of claim 15, wherein the updated network visualization data is configured to facilitate generation of a visualization of a network topography.

17. The non-transitory machine-readable medium of claim 16, wherein the visualization of the network topography is a hierarchical visualization.

18. A method, comprising:
obtaining, by a processing system including a processor, configuration data, wherein the configuration data comprises first configuration data indicative of a first configuration of a first component of a communications network and second configuration data indicative of a second configuration of a second component of the communications network, wherein the first configuration data is in a first format associated with a first component manufacturer, wherein the second configuration data is in a second format associated with a second component manufacturer, wherein the first component manufacturer is a different manufacturer than the second component manufacturer, and wherein the first format is a different format than the second format;
generating, by the processing system, a first prompt configured for input to a large language model (LLM), wherein the generating of the first prompt is based at least in part upon the first configuration data;
facilitating, by the processing system, input of the first prompt to the LLM;
responsive to the input of the first prompt to the LLM, receiving, by the processing system, a first knowledge graph that was generated by the LLM;
responsive to the receiving of the first knowledge graph, generating, by the processing system, a second prompt configured for input to the LLM, wherein the generating of the second prompt is based at least in part upon the first knowledge graph;
facilitating, by the processing system, input of the second prompt to the LLM;
responsive to the input of the second prompt to the LLM, receiving, by the processing system, first network visualization data that was generated by the LLM; and
outputting, by the processing system, the first network visualization data.

19. The method of claim 18, further comprising:
generating, by the processing system, a third prompt configured for input to the LLM, wherein the generating of the third prompt is based at least in part upon the second configuration data;
facilitating, by the processing system, input of the third prompt to the LLM;
responsive to the input of the third prompt to the LLM, receiving, by the processing system, a second knowledge graph that was generated by the LLM;
responsive to the receiving of the second knowledge graph, generating, by the processing system, a fourth prompt configured for input to the LLM, wherein the generating of the fourth prompt is based at least in part upon the second knowledge graph;
facilitating, by the processing system, input of the fourth prompt to the LLM;
responsive to the input of the fourth prompt to the LLM, receiving, by the processing system, second network visualization data that was generated by the LLM; and
outputting, by the processing system, the second network visualization data.

20. The method of claim 19, further comprising:
storing, by the processing system, the first knowledge graph in a database;
storing, by the processing system, the second knowledge graph in the database;
storing, by the processing system, the first network visualization data in the database; and
storing, by the processing system, the second network visualization data in the database;
wherein each of the first knowledge graph and the second knowledge graph is in a respective JavaScript Object Notation (JSON) LD file; and
wherein each of the first network visualization data and the second network visualization data is in a respective file that is in a JavaScript format.
